(19) United States
(12) Patent Application Publication
(10) Pub. No.: US 2013/0332252 A1
(43) Pub. Date: Dec. 12, 2013

(54) Real-Time Loyalty Management Engine

(71) Applicants: Marc-Oliver Klein, Mannheim (DE); Dennis Landscheidt, Mannheim (DE)

(72) Inventors: Marc-Oliver Klein, Mannheim (DE); Dennis Landscheidt, Mannheim (DE)

(73) Assignee: SAP AG, Walldorf (DE)

(21) Appl. No.: 13/492,010

(22) Filed: Jun. 8, 2012

(51) Int. Cl. G06Q 30/02

(52) U.S. Cl. 705/14.25; 705/14.27

(57) ABSTRACT

An interaction event associated with a customer is received by a real-time loyalty management engine executing on at least one data processor from an application. Thereafter, the engine retrieves data responsive to the interaction event that characterizes at least one loyalty program associated with the customer and a plurality of offerings. Next, the engine determines which of the offerings is most likely to result in an optimal conversion event based on the data characterizing the at least one loyalty program. The engine then transmits data to the application characterizing the determined offering to enable a transaction to be initiated based on the determined offering. Related apparatus, systems, techniques and articles are also described.

### TECHNICAL FIELD

The subject matter described herein relates to a software architecture incorporating a real-time loyalty management engine providing real-time contextual offerings to loyalty program participants.

### BACKGROUND

Companies are increasingly using loyalty programs (e.g., airline frequent flyer miles, hotel points, etc.) in an effort to obtain and retain customers. By providing awards (e.g., free flights, free hotel stays, etc.) after a certain number of loyalty points are accumulated, customers are motivated to continue to undertake activities that help them earn more loyalty points. Companies sometimes provide offerings to their loyalty program participants in an effort to generate further sales. However, such offerings are rarely specific and/or optimized for each customer which presents a lost opportunity for the companies.

### SUMMARY

In one aspect, an interaction event associated with a customer is received by a real-time loyalty management engine executing on at least one data processor from an application. Thereafter, the engine retrieves data responsive to the interaction event that characterizes at least one loyalty program associated with the customer and a plurality of offerings. Next, the engine determines which of the offerings is most likely to result in an optimal conversion event based on the data characterizing the at least one loyalty program. The engine then transmits data to the application characterizing the determined offering to enable a transaction to be initiated based on the determined offering.

The application can take the form of any of a plurality of applications in which it may be desirable to provide a real-time offering to a user. In example, the application can be a call center application providing an interface for a call center agent to interact with the customer in real-time.

The engine can include a processing layer, an administration stack, and an in-memory database. At least a portion of the data responsive to the interaction event can be replicated in the in-memory database, and such data can be retrieved from the in-memory database. The retrieved data can come from a variety of sources including, for example, a customer relation management (CRM) system and/or an analytics system.

The data characterizing the at least one loyalty program can identify a level of membership of the customer in each loyalty program. Such data can also characterize historical purchase behavior of the customer (which in turn can be used to determine the optimal conversion event). In some cases, the engine can also determine the optimal conversion event based on the level of membership for the customer.

The administration stack can include rules that are used by the processing stack to determine the offering most likely to result in an optimal conversion event.

After the offering has been determined, a transaction can be initiated via at least one computing system with the customer. The engine can later receive first data characterizing completion of the transaction which can result in the engine transmitting second data to a remote data source characterizing completion of the transaction to, for example, increase loyalty points for the customer and/or update his or historical purchase behavior.

The offering can comprise at least one product or service bundled with at least one incentive to earn further loyalty points of the loyalty program upon completion of a corresponding transaction.

The engine can include point simulation logic that determines which of the offerings is most likely to result in the optimal conversion event based on the data characterizing the at least one loyalty program.

Non-transitory computer program products are also described that store instructions, which, when executed by at least one data processor, causes at least one data processor to perform operations herein. Similarly, computer systems are also described that may include a processor and a memory coupled to the processor. The memory may temporarily or permanently store one or more programs that cause the processor to perform one or more of the operations described herein. In addition, methods can be implemented by one or more data processors either within a single computing system or distributed among two or more computing systems.

The subject matter described herein provides many advantages. For example, companies can increase the conversion rate of their various offerings by providing real-time and/or contextual offerings to loyalty point program participants. Such offerings can come from a variety of loyalty programs, and in some cases, offerings can be presented that give a user the ability to select from offers bundled with two or more loyalty programs. Such functionality can be particularly beneficial with regard to environments in which real-time interaction with a customer is desirable including, for example, a call-center environment in which a call center agent interacts with a customer via the phone and/or online, and/or an e-commerce website shopping basket and/or chat function.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a first process flow diagram illustrating an architecture including a real-time loyalty management engine;

FIG. 2 is a second process flow diagram illustrating an architecture including a real-time loyalty management engine; and

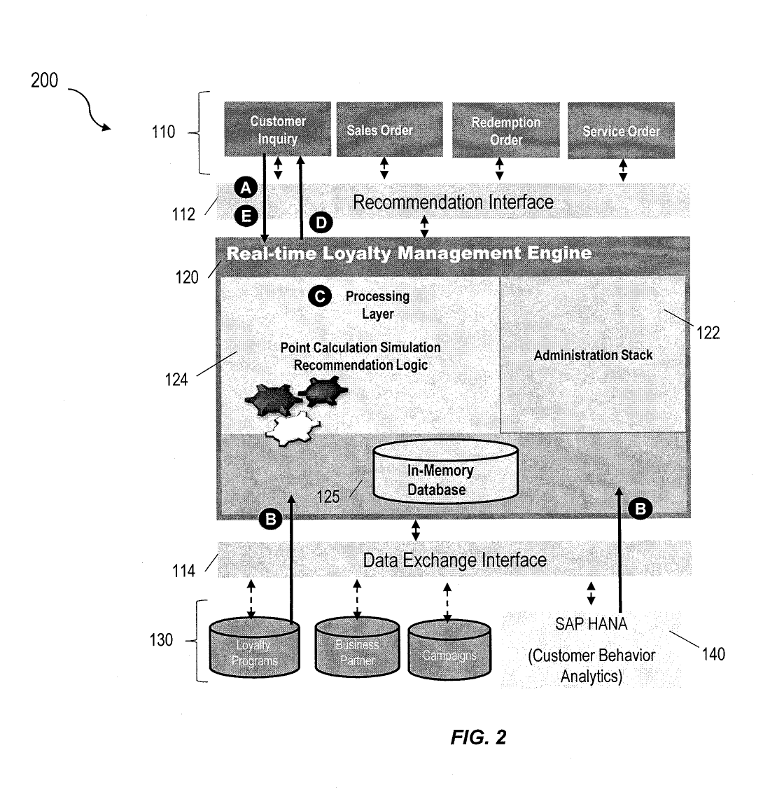

FIG. 3 is a process flow diagram illustrating initiation of an offering using a real-time loyalty management engine.

Like reference symbols in the various drawings indicate like elements.

### DETAILED DESCRIPTION

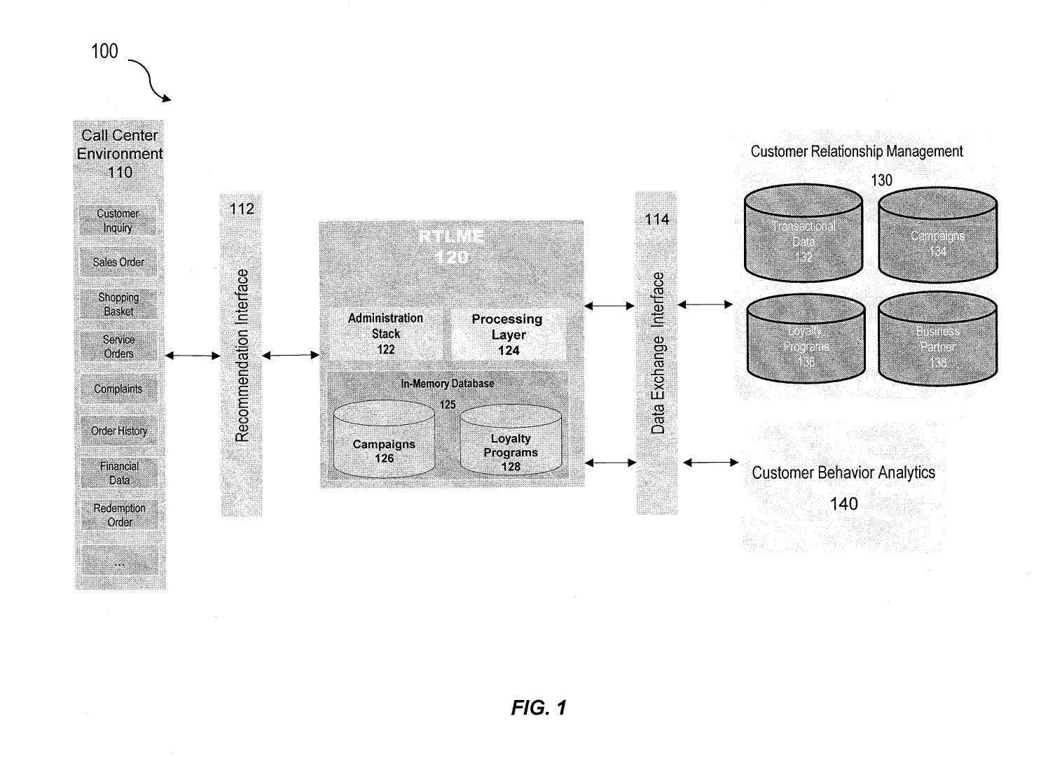

FIG. 1 is a diagram illustrating an architecture 100 that includes a call center environment 110, a real time loyalty management engine (RTLME) 120, a customer relationship management system 130, and a customer behavior analytics system 140.

The call center environment 110 can include various feature sets/modules that can be used by a call enter employee to interact with a customer and/or to otherwise obtain information about a customer. Such feature sets include, for example, customer inquiry interfaces and modules, sales order generation and status checking, shopping baskets to process sales of goods and services, service orders to service previously sold goods, a complaints interface to generate customer complaints and track status of same, a customer's order history, financial data of the customer (e.g., creditworthiness, sales, etc.), and redemption orders that allow, for example, for the redemption of stored value (e.g., frequent flyer miles, hotel points, etc.). The feature sets/modules of the call center environment 110 can interact with the RTLME 120 via a recommendations interface 112.

The RTLME 120 can include an administration stack 122 that defines various rules to be used by a processing layer 124 of RTLME 120. The RTLME 120 can include an in-memory database 125 that can store data generated by the RTLME 120 and can replicate data from external data sources. The in-memory database 125 can include a variety of tables and in particular, can include a campaigns data store 126 that stores various information relating to campaigns offering various products and services and to a loyalty programs data store 128 that includes various information about loyalty programs as a whole and/or to loyalty program accounts for each of a plurality of customers.

The RTLME 114 can communicate with the CRM system 130 and the analytics system 140 via a data exchange interface 114. The CRM system 130 can include various data stores such as a transactional data store 132 that includes data characterizing past transactions for the customer and/or other customers, a campaigns data store 134 that includes data characterizing various offerings for products, services, or other point award or redemption opportunities, and loyalty programs data store 136 that includes information about loyalty programs (both data unique to the user as well as data characterizing the loyalty program as a whole), and a business partner data store 138 that includes various information for a business partner involved with the offering.

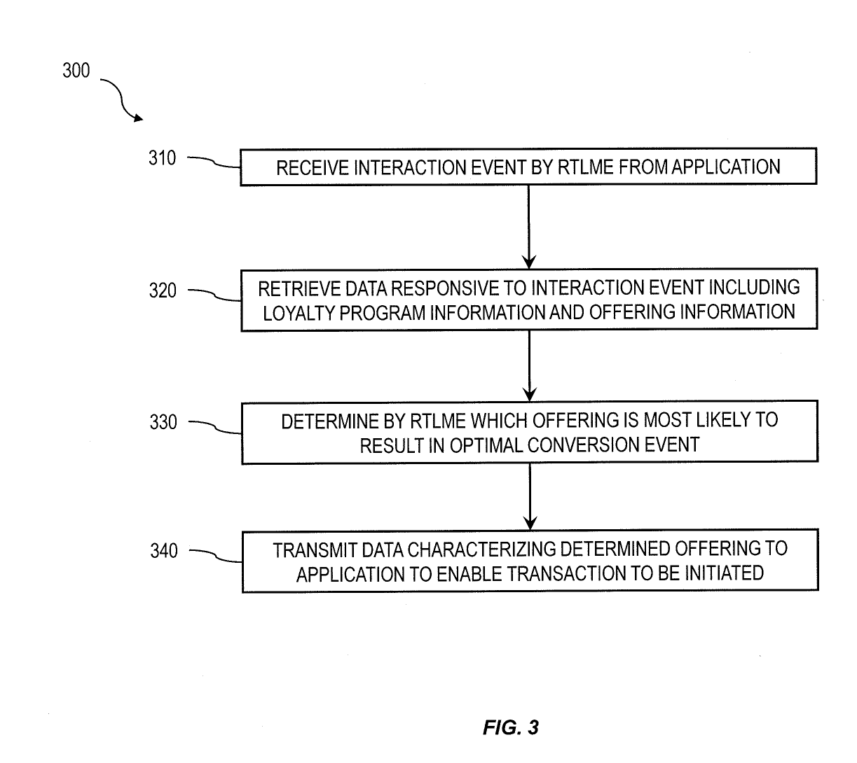

With reference to FIG. 3, a customer inquiry via the call center environment 110 results in an interaction event being transmitted, at A, to the RTLME 120 via the recommendations interface 112. The interaction event can include or otherwise characterize various types of data including an identity of the customer, an identity of a product or service for which the customer is inquiring, browsing, or otherwise considering to purchase. The interaction event can, in some cases, also identify a loyalty program and/or a loyalty program identifier for the customer.

Thereafter, at B, data responsive to (i.e., corresponding to or otherwise associated with, etc.) is retrieved from the CRM system 130 and the analytics system 140 via the data exchange interface 114 and stored in the in-memory database 125. The data from the CRM system 130 can include information about the loyalty programs such as the customers status level, the amount of loyalty points required to reach the next status level within the loyalty program, and the like. It will be appreciated the current subject matter can be implemented in an arrangement in which a single customer is presented with offerings from multiple loyalty programs and that the ultimate transaction need not be conducted by the loyalty program providers (i.e., any merchant can generate offerings that include loyalty point incentives provided that they properly compensate the loyalty program point providers for any awards, etc.).

The data from the CRM system 130 can also include business partner data that provides additional context data that can be used to identify an optimal offering as well as available campaigns (i.e., offerings) to present to the customer. The data from the analytics system 140 can characterize behavior of the customer and/or past behavior of other customers in similar situations as well as predictions of future behavior.

In some cases, such data retrieved from the CRM system 130 and the analytics system 140 prior to the receipt of the interaction event and replicated in the in-memory database 125.

The processing layer 124, at C, using the retrieved data and using rules specified by the administration stack 122, can determine which of various offerings from the CRM system 140 or from the in-memory database 125 are most likely to result in an optimal conversion event. The retrieved data can include, for example, loyalty program data (e.g., data for the program as a whole without reference to the customer), contextual loyalty program data for the user (e.g., points balance, etc.), as well as campaign data (e.g., data characterizing one or more incentives/offerings, etc.). An optimal conversion event is one that maximizes the overall benefit to the entity selling the product or service (i.e., it balances costs for such offering as compared to revenue, etc.). Real-time point simulation logic can determine which incentives (e.g., get 1,000 bonus points to allow customer to reach next level in loyalty program, etc.) for the optimal conversion event.

Data characterizing one or more possible offerings (i.e., recommendations, etc.) is then, at D, sent to the call center application 110. Feedback regarding the offering is then later, at E, received by the RTLME 120 so that the CRM system 130 and/or the analytics system 140 can be properly updated.

FIG. 3 is a process flow diagram 300 in which, at 310, a real-time loyalty management engine executing on at least one data processor receives an interaction event associated with a customer from an application. This interaction event can be any sort of request that is initiated by the application either manually by a user of the application (e.g., as part of a call center environment, etc.) or automatically as part of an automated computer process (e.g., an online transaction shopping cart, etc.). Thereafter, at 320, the engine retrieves data responsive to the interaction event that includes, at least, data characterizing at least one loyalty program associated with the customer and data characterizing a plurality of offerings. The engine then, at 330, determines which of the offerings is most likely to result in an optimal conversion event based on the data characterizing the at least one loyalty program. For example, the optimal conversion event can be calculated using rules of the engine (e.g., a 30% likelihood that the customer will buy a product above a pre-defined monetary threshold if the loyalty program incentive is offered, etc.). Thereafter, at 340, the engine transmits data to the application that characterizes the determined offering to enable a transaction to be initiated based on the determined offering.

### EXAMPLES

In a first example, Jeff Daniels is a customer of PC4YOU and silver member of the loyalty program. Jeff Daniels contacts the call center of PC4YOU. Angela Miles, the call center agent takes the call. As soon as the customer is identified, she can see the current membership level of Jeff (silver). Upon identification RTLME 120 is called in real-time and prompts the agent with a campaign that is relevant for Jeff: earn double points today. Angela Miles then creates a sales order for Jeff that includes a new laptop. As soon as the product is entered, RTLME 120 is triggered again. Now, the RTLME 120 comes back with another recommendation after checking Jeff's historic customer behavior, current campaigns and point simulation: buy also PC4YOU color printer 4s and with this purchase you will become gold member today. Jeff accepts the offer and the feedback is sent back to RTLME 120 so that Jeff's loyalty points can be updated.

In a second example, Jeff Daniels is on the website of an online merchant BOOKS4YOU. Jeff traverses the website to a page with a product NEWBOOK. The website transmits data identifying Jeff and NEWBOOK to the RTLME 120. The RTLME 120 using this information returns an offering for a second product NEWBOOK2 bundled with loyalty points for LOYALTYGROUP. The website transmits displays this offering for NEWBOOK2 concurrent with the NEWBOOK. Jeff Daniels then purchases NEWBOOK2 which results in data indicating same to be transmitted to the RTLME 120. The RTLME 120 then updates a remote data source so that the loyalty points for the LOYALTYGROUP can be increased for Jeff Daniels.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

1. A method comprising:
receiving, by a real-time loyalty management engine executing on at least one data processor of at least one computing system, an interaction event associated with a customer from an application;
retrieving, by the engine, data responsive to the interaction event, the retrieved data comprising data characterizing at least one loyalty program associated with the customer and data characterizing a plurality of offerings;
determining, by the engine, which of the offerings is most likely to result in an optimal conversion event based on the data characterizing the at least one loyalty program; and
transmitting, by the engine to the application, data characterizing the determined offering to enable a transaction to be initiated based on the determined offering:
wherein:
the engine comprises: a processing layer, an administration stack, and an in-memory database;
at least a portion of the data responsive to the interaction event is replicated in the in-memory database, and such data is retrieved from the in-memory database; and
the data replicated in the in-memory database is retrieved from at least one of a customer relation management (CRM) system and an analytics system.

2. A method as in claim 1, wherein the application comprises a call center application providing an interface for a call center agent to interact with the customer in real-time.

3-5. (canceled)

6. A method as in claim 1, wherein the data characterizing the at least one loyalty program comprises data identifying a level of membership of the customer in each loyalty program.

7. A method as in claim 6, wherein the data characterizing the at least one loyalty program comprises data characterizing historical purchase behavior of the customer.

8. A method as in claim 7, wherein the engine determines the offering most likely to result in an optimal conversion event based on the level of membership of the customer and based on the historical purchase behavior.

9. A method as in claim 3, wherein the administration stack comprises rules that are used by the processing stack to determine the offering most likely to result in an optimal conversion event.

10. A method as in claim 1, further comprising:
initiating, via at least one computing system, the transaction with the customer.

11. A method as in claim 10, further comprising:
receiving, by the engine, first data characterizing completion of the transaction; and
transmitting, by the engine to a remote data source, second data characterizing completion of the transaction.

12. A method as in claim 1, wherein the offering comprises at least one product or service bundled with at least one incentive to earn further loyalty points of the loyalty program upon completion of a corresponding transaction.

13. A method as in claim 1, wherein the engine includes point simulation logic that determines which of the offerings is most likely to result in the optimal conversion event based on the data characterizing the at least one loyalty program.

14. A non-transitory computer program product storing instructions, which when executed by at least one data processor, result in operations comprising:
receiving, by a real-time loyalty management engine executing on at least one data processor and comprising an in-memory database, an interaction event associated with a customer from an application;
retrieving, by the engine, data responsive to the interaction event, the retrieved data comprising data characterizing at least one loyalty program associated with the customer and data characterizing a plurality of offerings;
determining, by the engine, which of the offerings is most likely to result in an optimal conversion event based on the data characterizing the at least one loyalty program; and
transmitting, by the engine to the application, data characterizing the determined offering to enable a transaction to be initiated based on the determined offering.

15. A computer program product as in claim 14, wherein the application comprises a call center application providing an interface for a call center agent to interact with the customer in real-time.

16. A computer program product as in claim 14, wherein:
the engine comprises: a processing layer, and an administration stack
at least a portion of the data responsive to the interaction event is replicated in the in-memory database, and such data is retrieved from the in-memory database;
the administration stack comprises rules that are used by the processing stack to determine the offering most likely to result in an optimal conversion event;
the operations further comprise: retrieving the data replicated in the in-memory database from at least one of a customer relation management (CRM) system and an analytics system.

17. A computer program product as in claim 14, wherein:
the data characterizing the at least one loyalty program comprises data identifying a level of membership of the customer in each loyalty program;
the data characterizing the at least one loyalty program comprises data characterizing historical purchase behavior of the customer;
the engine determines the offering most likely to result in an optimal conversion event based on the level of membership of the customer and based on the historical purchase behavior.

18. A computer program product as in claim 14, wherein the operations further comprise:
initiating, via at least one computing system, the transaction with the customer;
receiving, by the engine, first data characterizing completion of the transaction; and
transmitting, by the engine to a remote data source, second data characterizing completion of the transaction.

19. A computer program product as in claim 14, wherein the offering comprises at least one product or service bundled with at least one incentive to earn further loyalty points of the loyalty program upon completion of a corresponding transaction.

20. A system comprising:
at least one data processor;
an in-memory database;
memory storing instructions, which when executed by the at least one data processor result in operations comprising:
receiving an interaction event associated with a customer from an application;
retrieving data responsive to the interaction event from the in-memory database, the retrieved data comprising data characterizing at least one loyalty program associated with the customer and data characterizing a plurality of offerings;
determining which of the offerings is most likely to result in an optimal conversion event based on the data characterizing the at least one loyalty program; and
transmitting data to the application characterizing the determined offering to enable a transaction to be initiated based on the determined offering.
